(19) United States
(12) Patent Application Publication
(10) Pub. No.: US 2024/0369834 A1
(43) Pub. Date: Nov. 7, 2024

(54) WAVEFRONT MANIPULATOR FOR ARRANGEMENT IN THE BEAM PATH OF A HEAD-UP DISPLAY COMPRISING A HOLOGRAPHIC ARRANGEMENT AS SOLE ABERRATION CORRECTION ELEMENT

(71) Applicant: Carl Zeiss Jena GmbH, Jena (DE)

(72) Inventor: Yi ZHONG-SCHIPP, Jena (DE)

(21) Appl. No.: 18/654,290

(22) Filed: May 3, 2024

(30) Foreign Application Priority Data
May 4, 2023 (DE) 102023111629.0

(51) Int. Cl. G02B 27/01; G02B 27/00

(52) U.S. Cl. CPC G02B 27/0103; G02B 27/0037; G02B 27/0172; G02B 2027/0125

(57) ABSTRACT

A Wavefront manipulator for arrangement in the beam path of a head-up display includes a holographic arrangement as sole aberration correction element. A wavefront manipulator can include a holographic arrangement for arrangement in the beam path of a head-up display between a picture generating unit and a projection surface. The holographic arrangement can be configured for arrangement as the sole aberration correction element between the picture generating unit and the projection surface.

### PRIORITY

This application claims the benefit of German Patent Application No. DE 102023111629.0, filed on May 4, 2023, which is hereby incorporated herein by reference in its entirety.

### FIELD

The present invention relates to a wavefront manipulator for arrangement in the beam path of a head-up display (HUD) between a projection lens and a projection surface, in particular a curved projection surface. Furthermore, the invention relates to a method for producing a holographic arrangement of a wavefront manipulator. The invention furthermore relates to an optical arrangement and to a head-up display.

### BACKGROUND

Head-up displays are now being used in the context of diverse applications, inter alia also in association with observation windows of vehicles, for example on windshields of motor vehicles, front screens or observation windows of aircraft. These viewing windows, and in particular windshields, usually have a curved surface which is used as a projection surface of head-up displays.

A head-up display usually comprises a picture generating unit (PGU) or a projector, a projection surface, an eyebox and a virtual image plane. An image representation is generated by means of the picture generating unit or the projector. The image is projected onto the projection surface and is projected from the projection surface into the eyebox. The eyebox is a plane or a spatial region in which the projected image is perceptible to a viewer as a virtual image. The virtual image plane, which is to say the plane on which the virtual image is generated, is arranged on or behind the projection surface.

Imaging aberrations, or aberrations, occur as a result of the curvature of the projection surface and as a result of compact arrangements in a small installation space with, under certain circumstances, severe tilting of individual components with respect to one another and correspondingly complexly folded beam paths. A windshield can generally be described as an optical freeform surface. If a head-up display is used in association with a curved windshield or a curved observation window, then it is desirable to correct imaging aberrations that occur as a result of the curvature, the abovementioned imaging aberrations that occur for reasons of structural space, under certain circumstances, and imaging aberrations caused by the picture generating unit, if appropriate, in the optical beam path. The imaging aberrations, or aberrations, which can occur in this case are, for example, distortion, defocus, tilting, astigmatism, curvature of the image plane, spherical aberrations, higher astigmatism and coma. Moreover, the largest possible field of view, the largest possible eyebox and also a uniform, bright and multicolored image representation, preferably multicolored at each image point, are desirable in association with head-up displays, in particular for vehicle applications.

The documents DE 10 2007 022 247 A1, DE 10 2015 101 687 A1, DE 10 2017 212 451 A1 and DE 10 2017 222 621 A1 describe head-up displays for vehicles, wherein holographic optical elements are employed in DE 10 2007 022 247 A1 and DE 10 2017 212 451 A1. The documents JP 2021-012 255 A and JP 2015-18 099 A disclose head-up displays comprising a tilted virtual image plane. The documents JP 2020-34 602 A and JP 2008-158203 A disclose head-up displays for motor vehicles. The document US 2006/0 132 914 A1 describes displaying an image representation against a background, in particular in the context of a head-mounted display.

Moreover, an efficient reduction of the installation space required for the components of a head-up display and a reduction of the component parts required for realizing the beam path and for correcting aberrations, in particular the imaging aberrations mentioned above, are striven for.

### SUMMARY

It is an object to provide an advantageous wavefront manipulator for arrangement in the beam path of a head-up display. Additional objects include providing an advantageous method for producing a holographic arrangement of a wavefront manipulator, an advantageous optical arrangement for a head-up display, and an advantageous head-up display.

The wavefront manipulator in one example includes a holographic arrangement and is designed for arrangement in the beam path of a head-up display, e.g. a head-up display of a vehicle, between a picture generating unit and a projection surface, e.g. windshield. The holographic arrangement is designed for arrangement as the sole aberration correction element between the picture generating unit and the projection surface. Preferably, the holographic arrangement is designed for correcting a plurality of aberrations (imaging aberrations).

The wavefront manipulator herein has the advantage that installation space is saved in comparison with the previously known solutions. In particular, the otherwise customary at least one additional component for beam deflection which is often present as a reflective element, for example as a freeform mirror, in the beam path of an HUD is dispensed with. Moreover, mounting and alignment are simplified, improved and made more cost-effective since fewer components are to be mounted and aligned. Firstly, a large number of aberrations can be corrected by means of the holographic arrangement of the wavefront manipulator and, secondly, the beam path can be shaped in accordance with the respective requirements by means of a design of the holographic arrangement with a corresponding refractive power.

Preferably, the holographic arrangement comprises a plurality of holograms which are configured to be transmissive and/or reflective. Moreover, the holograms can be configured to be reflective for at least one defined wavelength and a defined angle of incidence range. For example, the holographic arrangement can comprise at least two holographic elements which are arranged one directly behind another at least in portions in the beam path. The at least two holographic elements are arranged one directly behind another at least in portions in the beam path. In other words, no further optical element or component is arranged between the at least two holographic elements.

The at least two holographic elements can furthermore be configured to be reflective for at least one defined wavelength, in particular at least one defined wavelength range, and a defined angle of incidence range, a first holographic element comprising at least one hologram which is assigned to a hologram of a second holographic element for reflection purposes. In other words, the at least two holographic elements are designed such that light having at least one wavelength and at least one angle of incidence that is reflected by a first holographic element is reflected by the second holographic element.

Preferably, the holographic elements are configured to be transmissive for the rest. The second holographic element can be arranged in the beam path upstream of the first holographic element. In this variant, therefore, the light beams are at least partly transmitted through this before the light beams are reflected at the first holographic element. Advantageously, the at least two holographic elements are configured to be transmissive for defined wavelength ranges and/or at least one defined angle of incidence range for which they are configured not to be reflective.

The at least two holographic elements are configured to be reflective for example for at least two defined wavelengths which differ from one another, and a defined angle of incidence range. Preferably, the at least two holographic elements are configured to be reflective for at least two defined wavelength ranges which differ from one another and do not overlap, and a defined angle of incidence range. Advantageously, the at least two holographic elements are configured to be transmissive for defined wavelength ranges and/or at least one defined angle of incidence range for which they are configured not to be reflective. Filter effects are reduced or avoided as a result.

In a further variant, the at least two holographic elements are arranged at a distance from one another of a maximum of 50 millimeters, e.g. a maximum of 10 millimeters, preferably a maximum of 1 millimeter. In addition or as an alternative thereto, the at least two holographic elements can be arranged tilted in relation to one another, said elements forming an angle of a maximum of 60 degrees, e.g. a maximum of 30 or a maximum of 10 degrees, preferably a maximum of 5 degrees. In particular, the at least two holographic elements can have respective surface normals, the surface normals of two holographic elements forming an angle of a maximum of 60 degrees, e.g. a maximum of 30 or a maximum of 10 degrees, preferably a maximum of 5 degrees. The at least two holographic elements are preferably arranged parallel to one another and/or directly adjacent to one another. Preferably, the at least two holographic elements are arranged at a distance from one another of less than one millimeter, in particular of less than 0.5 millimeter, preferably of less than 0.1 millimeter. The distance is preferably zero or negligible. As a result, firstly, a high imaging quality is achieved; additionally, the individual holographic elements do not have to be subsequently adjusted in regard to their position with respect to one another.

The use of two holographic elements arranged one directly behind another and configured to be at least partly reflective has the advantage that in particular in association with a head-up display, a large field of view (FOV) can be attained with high efficiency and the imaging quality can be considerably improved by way of the individual configuration of the holographic elements. For this purpose, the holographic elements take up almost no installation space, and so when there is only little available installation space, such as in the case of a head-up display designed for a motor vehicle, for example, a significant increase in the imaging quality can be achieved by means of the wavefront manipulator. The holographic arrangement achieves a high refractive power, in particular, comparable with the refractive power such as is achieved for example by an optical component configured to be transmissive without chromatic aberration. Compared with transmission holograms, reflective holograms for a defined wavelength offer a broader angular spectrum with a high efficiency and a higher wavelength selectivity. As a result, the color channels can be separated from one another despite a broad angle of incidence spectrum and double images can be avoided. The holographic arrangement thus enables a large field of view (FOV) with high efficiency at the same time and is thus suitable both for VR head-up displays (VR—Virtual Reality) and augmented reality head-up displays (AR HUDs) with a large field of view and a large aperture. Further application possibilities are afforded by head-up displays having curved production surfaces, for example head-up displays for windshields of vehicles, in particular motor vehicles, aircraft or ships, and generally for observation windows. Moreover, aberrations caused by a tilting of the image plane, such as brightness differences and distortions, for example, can also be corrected by means of the holographic arrangement.

A further advantage achieved by the holographic arrangement is that, on account of the high diffraction angle of the holographic arrangement, the proportion of the light from unused orders of diffraction which is reflected into the eyebox is reduced. Furthermore, high-quality multicolored image representations can be generated.

Advantageously, the wavefront manipulator is designed for manipulating a wavefront for generating a multicolored virtual image representation. This is taken to mean that a multicolored virtual image representation is generable at every point on the image plane. The wavefront manipulator can thus be designed to manipulate light with the wavelengths or frequencies of at least one defined color space and to convert it into a multicolored virtual image representation in the context of a head-up display. In other words, the wavefront manipulator can be designed for a picture generating unit for generating a multicolored image representation. In this case, the picture generating unit can be designed to emit light with the wavelengths or frequencies of at least one defined color space. The color space can be, for example, an RGB color space (RGB—Red Green Blue) or a CMY color space (CMY—Cyan Magenta Yellow).

Preferably, each of the at least two holographic elements comprises a number of holograms. In this case, each hologram is recorded or generated with at least one defined wavelength. A holographic element can comprise a plurality of holograms, for example, which can be arranged one on top of another as a stack. By way of example, a holographic element can have a number, preferably a plurality, of monochromatic holograms. As an alternative thereto, a holographic element can comprise at least one hologram which is recorded or generated with at least two defined wavelengths. Preferably, such a hologram is recorded with three different wavelengths of a defined color space, for example is configured as an RGB hologram or a CMY hologram or as a hologram formed from a number of individual wavelengths of a different color space. In the examples mentioned, R stands for Red, G stands for Green, B stands for Blue, C stands for Cyan, M stands for Magenta, and Y stands for Yellow.

Therefore, at least one, preferably two, of the at least two holographic elements can comprise at least two, preferably three, holograms which are configured to be reflective for mutually different wavelengths. In addition or as an alternative thereto, at least one, preferably two, of the at least two holographic elements can comprise at least one hologram which is configured to be reflective for at least two, preferably three, mutually different wavelengths. In other words, the holograms mentioned have been recorded with correspondingly mutually different wavelengths.

For example, from the at least two holographic elements, a first holographic element can comprise at least one hologram which is designed or efficient for a first color, preferably three holograms, each of which is designed for one of the three colors of a color space, and a second holographic element can comprise at least one hologram which is designed or efficient for the first color, preferably three holograms, each of which is designed for one of the three colors of the color space. The two holographic elements can be arranged against one another such that a stack composed of the holograms of the first holographic element is arranged against a stack composed of the holograms of the second holographic element. However, holograms assigned to one another can also be arranged directly adjacent to one another. In this case, only individual portions of the holographic elements are arranged one directly behind another. That is to say that, for example, that hologram of the first holographic element which is designed for a first color can be arranged directly adjacent to that hologram of the second holographic element which is designed for the first color, that hologram of the first holographic element which is designed for a second color can be arranged directly adjacent to that hologram of the second holographic element which is designed for the second color, etc.

The arrangement of the individual holograms of a holographic element or of the totality of the holograms of the holographic arrangement can be used as a degree of freedom in order to avoid filter effects between the holograms. The individual, mutually differing holograms of a holographic element can be arranged next to one another and/or one behind another in relation to a center line or center axis, which can coincide with the optical axis, or in relation to some other defined geometric parameter of the holographic element.

By way of example, the first holographic element can be arranged mirror-symmetrically with respect to the second holographic element in relation to the arrangement of the individual holograms. For example, the first holographic element can comprise a hologram recorded with red light, a hologram recorded with green light and a hologram recorded with blue light, which are arranged one on top of another in the order mentioned. The second holographic element can likewise have a hologram recorded with red light, a hologram recorded with green light and a hologram recorded with blue light, which are likewise arranged one on top of another in this order. In the case of a mirror-symmetrical arrangement, the first holographic element and the second holographic element are arranged one on top of another or adjacent to one another in such a way that for example the hologram of the first holographic element recorded with red light is arranged directly adjacent to the hologram of the second holographic element recorded with red light. As an alternative thereto, the arrangement of the holograms of the first holographic element can be identical to the arrangement of the holograms of the second holographic element in relation to a defined direction. For example, both holographic elements can have holograms arranged in the order RGB (R—hologram recorded with red light, G—hologram recorded with green light, B—hologram recorded with blue light) in relation to a defined direction, which are arranged against one another in such a way that the hologram R of one holographic element adjoins the hologram B of the other holographic element. Any other mutually different arrangements are likewise possible, for example RGB adjoining or adjacent to GBR, or R adjoining or adjacent to R, G adjoining or adjacent to G, and B adjoining or adjacent to B, etc.

In the simplest case, the holographic arrangement can comprise a first holographic element and a second holographic element, a plurality of the holograms or all of the holograms of the respective holographic element being configured identically or the same, with the exception of the wavelength for which they are designed. In other words, a plurality or all of the holograms of the first holographic element can be configured identically and can differ from one another only in regard to the wavelength for which they are designed. Analogously, a plurality or all of the holograms of the second holographic element can be configured identically and can differ from one another only in regard to the wavelength for which they are designed.

In a further variant, a plurality of the holograms of at least one of the holographic elements are recorded with two design wavefronts. Of the latter, at least one design wavefront of at least one hologram of the holographic elements can be identical to at least one design wavefront of another hologram of one of the holographic elements, in particular of the first and/or of the second holographic element, with regard to the wavelength and the angle of incidence. The use of identical design wavefronts for different wavelengths has the advantage that the required holograms can be produced with little outlay and high precision. However, it is also possible for the design wavefronts to slightly differ from one another with regard to the wavelength and/or the angle of incidence. For example, the angles of incidence can differ from one another by 1 to 2 degrees. The difference can be used to compensate for material shrinkage and to optimize the homogeneity of the efficiency.

The jointly used design wavefront is preferably defined as a plane wave which leads to a minimal filter effect between different wavelengths. The direction of incidence of the design wavefront for the at least two holographic elements of the holographic arrangement can be used as a degree of freedom in order to avoid filter effects between different wavelengths. The direction of incidence can also be chosen differently for each wavelength. In a simple case, the design wavefronts for the at least two wavelengths, preferably for this the three wavelengths, are the same design wavefronts for each holographic element and differ only in the wavelength used.

The holographic arrangement, in particular at least one of the holographic elements, is preferably configured such that it transforms a spherical wave into a plane wave. As a result, the holographic arrangement, in particular the holographic element, has a high refractive power, without the volume and thus the required installation space being increased.

In principle, the at least two holographic elements can comprise reflection holograms recorded with two design wavefronts, of which at least one design wavefront is preferably a freeform wavefront or a plane wavefront or a spherical wavefront. In this case, a freeform wavefront has the shape of a freeform surface.

A freeform surface should be understood in the broader sense to mean a complex surface that can be represented, in particular, by means of regionally defined functions, in particular twice continuously differentiable regionally defined functions. Examples of suitable regionally defined functions are (in particular piecewise) polynomial functions (in particular polynomial splines, such as for example bicubic splines, higher-degree splines of the fourth degree or higher, or polynomial non-uniform rational B-splines (NURBS)). These should be distinguished from simple surfaces, such as e.g. spherical surfaces, aspherical surfaces, cylindrical surfaces, and toric surfaces, which are described as a circle, at least along a principal meridian. In particular, a freeform surface need not have axial symmetry and need not have point symmetry and can have different values for the mean surface power value in different regions of the surface.

In connection with correcting a plurality of aberrations, it is advantageous if the at least two holographic elements comprise reflection holograms, at least one reflection hologram being recorded or written with two design wavefronts, at least one of the design wavefronts being designed such that they are generated in accordance with a function or formation specification comprising polynomials, for example, which has a plurality of degrees of freedom, i.e. a plurality of parameters that are settable independently of one another. The highest possible number of degrees of freedom is required for effectively correcting as many imaging aberrations as possible. This can be realized by way of corresponding design wavefronts by means of a single compact component.

At least one of the holographic elements can be configured efficiently for a plurality of angles of incidence and/or for a plurality of angle of incidence ranges that do not overlap one another. The at least two holographic elements are preferably configured such that a first holographic element comprises at least one hologram assigned to a hologram of a second holographic element, holograms assigned to one another being configured with pointwise diffraction efficiency in relation to one another. In order to determine the diffraction efficiency, either the intensity of the 1 st order of diffraction is expressed as a ratio with respect to the sum of the intensity of the 1 st order of diffraction and the intensity of the 0 order of diffraction, or the intensity of the 1st order of diffraction is expressed as a ratio with respect to the total incident intensity. Pointwise diffraction efficiency thus means, in other words, that at least one point of the first holographic element is designed to diffract light having at least one defined wavelength and in a defined angle of incidence range to a point of the second holographic element which in turn diffracts the light diffracted by the first holographic element. Preferably, the efficiency is more than 90 percent.

The distance between the holograms and the thickness thereof are negligible compared with the dimension or the extent of the wavefront manipulator or of an optical arrangement comprising the wavefront manipulator. The holographic arrangement is therefore free of aberrations potentially caused by an extent in the direction of an optical axis. The design wavefronts of the holographic elements can furthermore be used as a degree of freedom for the compensation of material tolerances, for example for the compensation of material shrinkages. In this case, the general design wavefronts differ slightly from one another.

The holographic arrangement can be configured in the form of a layer or a film or a substrate, for example in the form of a volume hologram, or a plate. In addition or as an alternative thereto, the holographic arrangement can have a planar surface or a curved surface. The holographic arrangement can be arranged or have been arranged for example at or on a surface of a cover glass or of some other optical component that is present anyway. In this way, no additional installation space is taken up. For example, the wavefront manipulator can comprise an optical component configured to be transmissive and designed to be arranged in the beam path between the holographic arrangement and the projection surface. In this case, the holographic arrangement can preferably be arranged at a surface—which faces away from the projection surface—of the optical component configured to be transmissive.

Both the optical component fashioned to be transmissive and the holographic arrangement can be configured to be curved, preferably with the same curvature. The aforementioned optical component fashioned to be transmissive can be a so-called glare trap, for example, which is usually arranged at a position between a windshield and a head-up display and which is designed to reflect sunlight in a defined direction so that it is not reflected in the direction of the eyebox via the head-up display. In this configuration variant, the holographic arrangement and the glare trap are preferably configured with the same curvature and arranged directly adjacent to one another.

The holographic arrangement can be configured in curved fashion. This affords greater flexibility in the use of the installation space and an additional degree of freedom for correcting aberrations. Advantageously, the holographic arrangement is designed for at least partly correcting at least one aberration which is caused by a curvature of the projection surface and/or by the picture generating unit and/or by the course of the beam path and/or by at least one optical element in the beam path and/or by a tilting of the image plane.

In one preferred variant, the at least two holographic elements comprise reflection holograms recorded with two design wavefronts, of which at least one design wavefront is a freeform wavefront. The at least two holographic elements can comprise reflection holograms, at least one reflection hologram being recorded with two design wavefronts, at least one of the design wavefronts being designed such that they are generated in accordance with a function having a plurality of degrees of freedom. The greater the number of degrees of freedom, the more efficiently and more versatilely a plurality of aberrations can be at least partly corrected.

In an example method herein for producing a holographic arrangement of an above-described wavefront manipulator is distinguished by the fact that at least one hologram is generated by exposure with at least one design wavefront configured as a freeform wavefront, for example by exposure with a plurality of design wavefronts configured as a freeform wavefront. This enables a wavefront manipulator to be produced simply and cost-effectively. The use of freeform wavefronts as design wavefronts has the advantage that the holograms can be written in such a way that they correct a plurality of aberrations. In this case, for example, an individual hologram can be designed for correcting a plurality of aberrations. Correction of aberrations can thus be realized for a large number of different aberrations by means of a single holographic arrangement.

The at least one freeform wavefront can be generated via a freeform lens and/or a freeform mirror and/or a freeform hologram. Moreover, at least one hologram can be generated by exposure with at least one plane wavefront and/or at least one spherical wavefront. Any desired combination of freeform wavefronts, plane wavefronts and spherical wavefronts is thus possible in the context of configuring the design wavefronts.

An optical arrangement in an example herein for a head-up display or of a head-up display comprises a picture generating unit and a wavefront manipulator as already described. It can be designed for a head-up display on a projection surface, for example a curved projection area or projection surface. The projection surface can be an area or surface of a windshield of a vehicle or an observation window.

Preferably, the optical arrangement does not comprise a mirror, in particular a mirror in the beam path proceeding from the picture generating unit as far as the wavefront manipulator and/or as far as a projection surface. In other words, therefore, apart from reflection holograms of the holographic arrangement of the wavefront manipulator, the optical arrangement does not comprise a mirror, in particular a reflective element for beam deflection and/or aberration correction. This has the advantage that the number of required components and thus installation space can be reduced.

The optical arrangement herein has the features and advantages already mentioned above in connection with the wavefront manipulator. It enables in particular a head-up display which is fashioned very compactly, i.e. occupies just a small installation space, and at the same time ensures a very high imaging quality.

The picture generating unit advantageously comprises an object plane, i.e. is spatially extended, the object plane being designed to emit light in a defined emission angle range and with a defined maximum bandwidth with regard to the wavelengths of the emitted light. The object plane can be determined or defined by the exit pupil of the picture generating unit. Preferably, the picture generating unit is designed for generating a multicolored image representation. For example, each light-emitting point of the object plane emits light in the form of a scattering lobe or in a defined angular range. This can be achieved for example by the use of a diffuser. Preferably, the picture generating unit is designed to emit laser light, in particular laser beams. Advantageously, the picture generating unit is designed to emit laser light in at least two, preferably at least three, different waves. That preferably involves three different wavelengths of a defined color space, for example red, green and blue or cyan, magenta and yellow. Since the holographic elements are more sensitive with regard to the bandwidth of each wavelength compared with other optical components, such as mirrors and lens elements, for example, it is advantageous if the picture generating unit is configured as a laser scanner having a sharp bandwidth for each color.

The optical arrangement preferably has a volume of less than 15 liters, e.g. less than 9 liters, i.e. in other words occupies an installation space of less than 9 liters. Installation space and costs are thus reduced by virtue of the reduced number of components.

Both the wavefront manipulator and the optical arrangement are suitable for retrofitting in for example motor vehicles, rail vehicles, aircraft or VR arrangements, for example VR glasses.

The head-up display comprises an above-described optical arrangement. It can be configured as a head-up display of a vehicle. The vehicle can be a motor vehicle, a rail vehicle, an aircraft or a ship. The motor vehicle can be an automobile, a truck, a motorbike, a moped, a bus or a minibus.

The head-up display can comprise a projection surface, for example a curved projection area or projection surface. The projection surface is, for example, a windshield of a vehicle, for example of a motor vehicle, of an aircraft or of a ship. However, the curved projection surface can also be some other observation window, for example an observation window of VR glasses. The curved projection surface can be regarded as a freeform surface, for example. Imaging aberrations, or aberrations, that are caused thereby, inter alia, are compensated for by means of the wavefront manipulator.

Preferably, the head-up display does not comprise a mirror in the beam path proceeding from the picture generating unit as far as a projection surface. In other words, therefore, apart from a projection surface and apart from reflection holograms of the holographic arrangement of the wavefront manipulator, the head-up display does not comprise a mirror, in particular a reflective element for beam deflection and/or aberration correction. This has the advantage that the number of required components and thus installation space can be reduced.

The invention is explained in greater detail below on the basis of exemplary embodiments with reference to the accompanying figures. Although the invention is more specifically illustrated and described in detail by means of the preferred exemplary embodiments, nevertheless the invention is not restricted by the examples disclosed and other variations can be derived therefrom by a person skilled in the art, without departing from the scope of protection of the invention.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present invention in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

FIG. 1 schematically shows the beam path of a head-up display according to certain embodiments of the invention for a windshield of a motor vehicle in a side view.

FIG. 2 schematically shows a holographic arrangement of an exemplary variant of a wavefront manipulator according to certain embodiments of the invention.

FIG. 3 schematically shows the beam path within a hologram stack.

FIGS. 4-10 schematically show examples of in each case two reflection holograms assigned to one another with their design wavefronts.

FIG. 11 schematically shows the generation of a freeform design wavefront via a freeform lens.

FIG. 12 schematically shows the generation of a freeform design wavefront via a freeform mirror.

FIG. 13 schematically shows the generation of a freeform design wavefront via a freeform transmission hologram.

FIG. 14 schematically shows the generation of a freeform design wavefront via a freeform reflection hologram.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

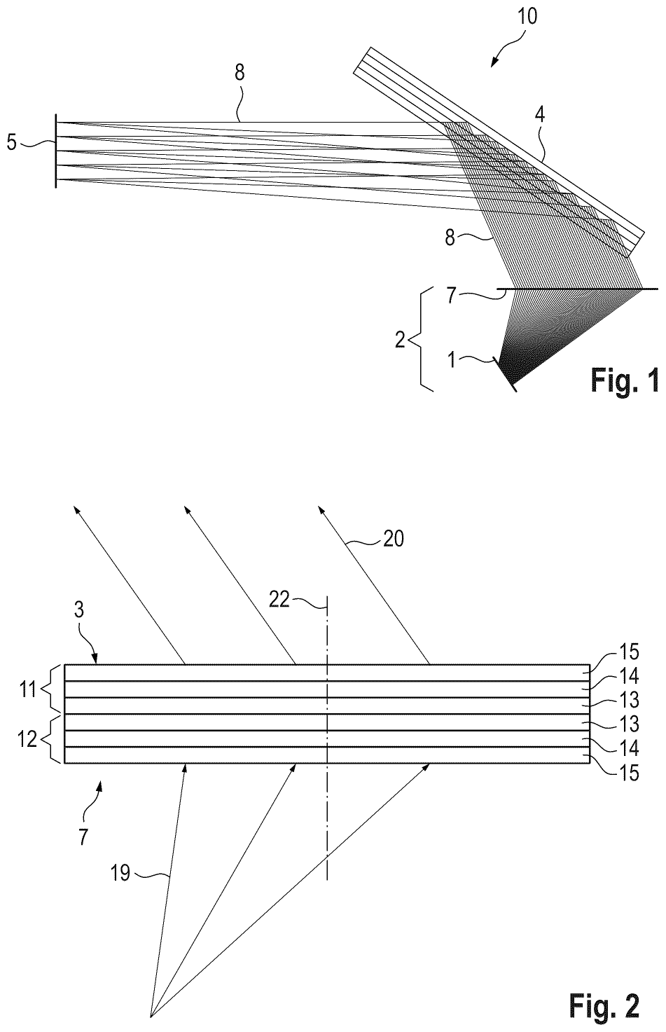

FIG. 1 schematically shows the beam path of a head-up display 10 with an optical arrangement 2. The head-up display 10 comprises a picture generating unit 1, a projection surface 4, for example in the form of a windshield of a motor vehicle, and a wavefront manipulator 7. The projection surface 4, for example the windshield, can be configured in curved fashion. In the case of an application for a vehicle, the picture generating unit 1 and the wavefront manipulator 7 are preferably arranged in a manner integrated in a fitting (not shown). The head-up display 10 is configured such that it generates a virtual image 6 on the projection surface 4, in particular on the surface of the windshield or in the external region of the vehicle, for example in the direction of travel behind the surface of the windshield.

In the configuration variant shown, the wavefront manipulator 7 comprises a holographic arrangement arranged as the sole aberration correction element in the beam path 8 proceeding from the picture generating unit 1 between the picture generating unit 1 and the projection surface 4.

The picture generating unit 1 emits light waves in the direction of the wavefront manipulator 7. The wavefront manipulator 7 is used to correct imaging aberrations and optionally to expand the beam path. The wavefront manipulator 7 guides light waves in the direction of the projection surface 4, in particular the curved projection surface. At the projection surface 4, the light waves are reflected in the direction of an eyebox 5. In this case, the eyebox 5 forms the region in which a user must or can be situated in order to be able to perceive the virtual image generated by the head-up display 10.

FIG. 2 schematically shows a holographic arrangement 3 of a wavefront manipulator 7. The wavefront manipulator 7 has the holographic arrangement 3. The holographic arrangement 3 comprises a first holographic element 11 and a second holographic element 12. In the embodiment variant shown, the first holographic element 11 and the second holographic element 12 each have three monochromatic holograms arranged one on top of another, of which by way of example a hologram recorded with red light is identified by the reference numeral 13, a hologram recorded with green light is identified by the reference numeral 14 and a hologram recorded with blue light is identified by the reference numeral 15. The first holographic element 11 and the second holographic element 12 are arranged against one another in such a way that the individual holograms are arranged mirror-symmetrically with respect to one another. In the variant shown, the holograms 13 recorded with red light are arranged directly adjacent to one another. The first holographic element 11 and the second holographic element 12 can be directly adjacent to one another or can be arranged at a negligible distance from one another, preferably at a distance of less than 3 millimeters, e.g. less than 2 millimeters.

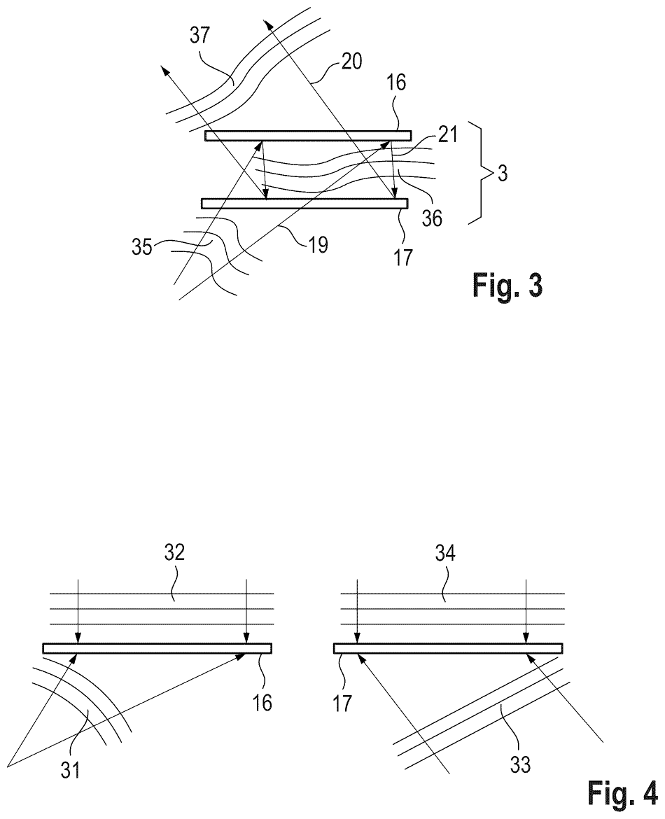

In FIG. 2, the incident light waves in the form of beams are identified by arrows with the reference numeral 19 and the beam path of the light leaving the wavefront manipulator 7 is identified by arrows with the reference numeral 20. In the variant shown in FIG. 3, the individual, mutually differing holograms 13, 14 and 15 of the individual holographic elements 11 and 12 are arranged one behind another in relation to a center line or center axis 22, which can be an optical axis, along the latter. Individual, mutually differing holograms 13, 14 and 15 of the individual holographic elements 11 and 12 can also be arranged laterally with respect to one another in relation to a center line or center axis 22.

In a further embodiment variant of a wavefront manipulator 7, in a departure from the variant shown in FIG. 2, the first holographic element 11 and the second holographic element 12 can each comprise only one hologram, which however is recorded in each case with light having a number of different wavelengths. By way of example, this can involve two RGB holograms. The holograms have for example hologram grating structures produced with red light, hologram grating structures recorded with green light and hologram grating structures recorded with blue light.

FIG. 3 shows the beam path through a hologram stack constructed from the holograms 16 and 17, for example in the context of an optical arrangement or an HUD 10. The hologram 16 can be part of the first holographic element 11, and the hologram 17 can be part of the second holographic element 12.

Light with a corresponding wavefront coming from the picture generating unit 1 is guided in the direction of the holographic arrangement 3. The light or the wavefront 35 is firstly transmitted through the second hologram 17 and is subsequently reflected at the first hologram 16. The wavefront reflected by the first hologram 16 is identified by the reference numeral 36, and the corresponding beam path is identified by the reference numeral 21. This wavefront 36 is reflected at the second hologram 17 and subsequently transmitted by the first hologram 16. The corresponding wavefront 37 subsequently leaves the holographic arrangement 3 and is guided in the direction of the projection surface 4.

Reflection holograms 16 and 17 assigned to one another, i.e. holograms which are designed for reflecting wavelengths or frequencies coordinated with one another, i.e. identical wavelengths or frequencies or wavelength ranges or frequency ranges which at least partly overlap one another, and/or for angle of incidence ranges coordinated with one another or have at least a pointwise mutual efficiency, can be arranged directly adjacent to one another within the holographic arrangement 3, as shown in FIG. 2. However, it can also comprise a first holographic element 11 comprising a plurality of first holograms which are designed and are efficient in each case for different wavelengths or wavelength ranges, and a second holographic element 12 comprising a plurality of second holograms which are respectively assigned to the first holograms, i.e. are designed or efficient for the same wavelengths or wavelength ranges as the first holograms. In this case, the first holographic element 11 and the second holographic element 12 can preferably be arranged directly adjacent to one another. In order to avoid filtering effects, the holograms are preferably designed to be transmissive for those wavelengths or frequencies of the color space used for which they are not efficient or designed as reflection holograms.

Freeform wavefronts for the hologram design are also suitable for realizing other HUD systems with high specifications, for example in order to realize a large eyebox and a large FOV. Application options correspondingly arise for the wavefront manipulator and the optical arrangement.

FIGS. 4 to 10 each show holograms designed for a specific wavelength or frequency or for a specific wavelength range or frequency range. With reference to FIGS. 4 to 10, an explanation is given hereinafter of examples of in each case two holograms 16 and 17 of the holographic elements 11 and 12, respectively, which are used as reflection holograms assigned to one another, with the design wavefronts thereof. The holograms 16 and 17 can be for example the holograms 13, 14 or 15 from FIG. 2. For example, the first holographic element 11 can comprise the hologram 16, and the second holographic element 12 can comprise the hologram 17.

In FIG. 4, a first hologram 16 for reflecting light having a defined wavelength, for example for green light, is shown on the left. A second hologram 17 is shown on the right, which is designed as a reflection hologram for light having the same wavelength as the first hologram 16 and which interacts with the first hologram 16, as shown in FIG. 3, in the context of the holographic arrangement 3. The design wavefronts for the first hologram 16 are identified by the reference numerals 31 and 32. The design wavefronts for the design of the second hologram 17 are identified by the reference numerals 33 and 34. In the example shown, the first hologram 16 is exposed, i.e. written, with a spherical wavefront 31 and a plane wavefront or planar wavefront 32, and the second hologram 17 is written with two planar wavefronts or plane wavefronts 33 and 34. The wavefronts 31 and 33 define the directions of the light toward the components, i.e. upon entering the holographic arrangement and upon exiting from the holographic arrangement, and also the refractive power of the entire holographic arrangement constructed from these holograms 16 and 17. The design wavefronts 32 and 34 define the reproduction wavefronts between the two holograms 16 and 17 (see wavefront 36 in FIG. 3). In this case, it is necessary to ensure that a filtering effect between different colors or wavelengths is avoided. Filtering effects are avoided by way of corresponding differences in the exposure wavelengths and/or a suitable definition of the exposure angles of the wavefronts 32 and 34. In the variant shown in FIG. 4, the directions of the wavefronts 32 and 34 are identical.

The wavefront 31 can be formed from a sum of a spherical wavefront and a freeform wavefront. In this case, the wavefront can be represented by a polynomial expansion of a sum of Zernike polynomials, the individual Zernike polynomials Z being multiplied by coefficients c(Z). The following table gives an example of suitable values for coefficients c(Z) of the Zernike polynomials Z5 to Z9, in particular for an arrangement with a non-curved windshield. The Zernike polynomial Z5 corrects astigmatism at 45°, Z6 corrects astigmatism at 0°, Z7 corrects coma in the x-direction, Z8 corrects coma in the y-direction, and Z9 corrects spherical aberration.

| c(Z5) | c(Z6) | c(Z7) | c(Z8) | c(Z9) |
|---|---|---|---|---|
| 1.23E−06 | 1.36E−06 | −1.02E−09 | −7.31E−15 | 3.02E−13 |

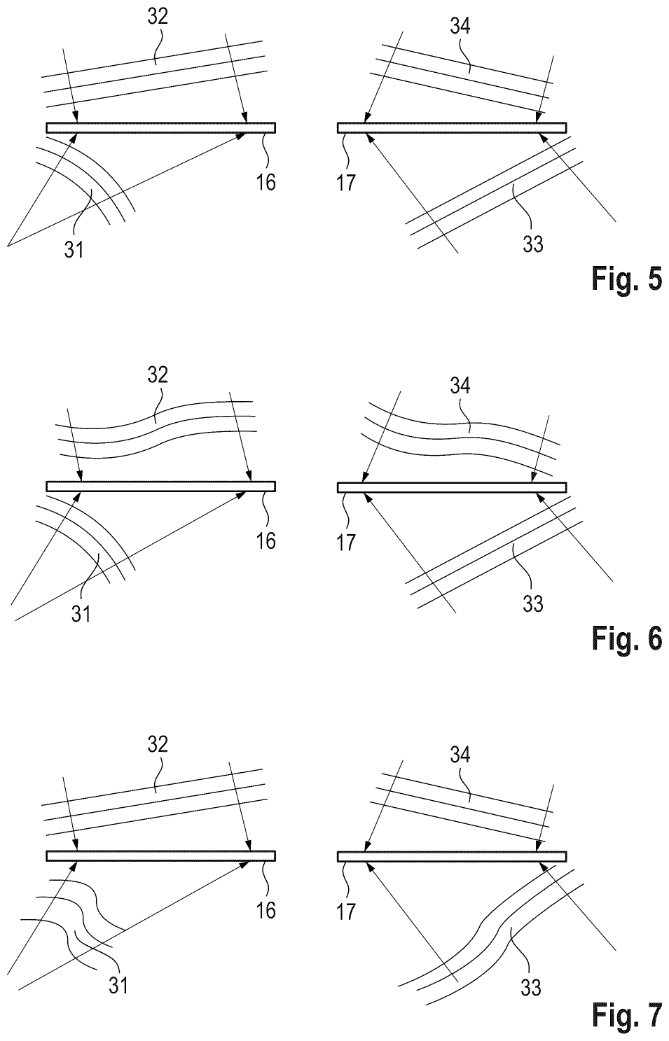

In the variant shown in FIG. 5, in order to improve the homogeneity of the brightness and the color homogeneity, two design wavefronts 32 and 34 differing from one another in terms of their direction of incidence are used.

In the variant as shown in FIG. 6, in contrast to the variant shown in FIG. 5, the design wavefronts 32 and 34 are designed as freeform wavefronts. The homogeneity can thereby be improved to an even higher level. The wavefronts 32 and 34 can be adjusted in particular locally by means of complicated exposure systems. The shape of the wavefronts and the angle of incidence can be specified in this way.

In the variant as shown in FIG. 7, the design wavefronts 31 and 33 are configured as freeform wavefronts, which moreover differ from one another with regard to their shape and their angle of incidence. The design wavefronts 32 and 34, as in FIG. 5, are designed as plane waves with mutually different angles of incidence.

The configurations shown offer a high number of degrees of freedom. Required degrees of freedom are usually implemented by freeform components. In the variant shown here, corresponding requirements can be realized by means of the holograms used, the required degrees of freedom being realized by a corresponding freeform exposure by means of the design wavefronts 31, 32, 33 and 34. For the imaging quality and in particular the aberration correction, the freeform wavefronts 31 and 33 in the variant shown in FIG. 7 are used. As a result, the holograms 16 and 17 designed or written in this way bear complicated microstructures that are designed to correct numerous aberrations.

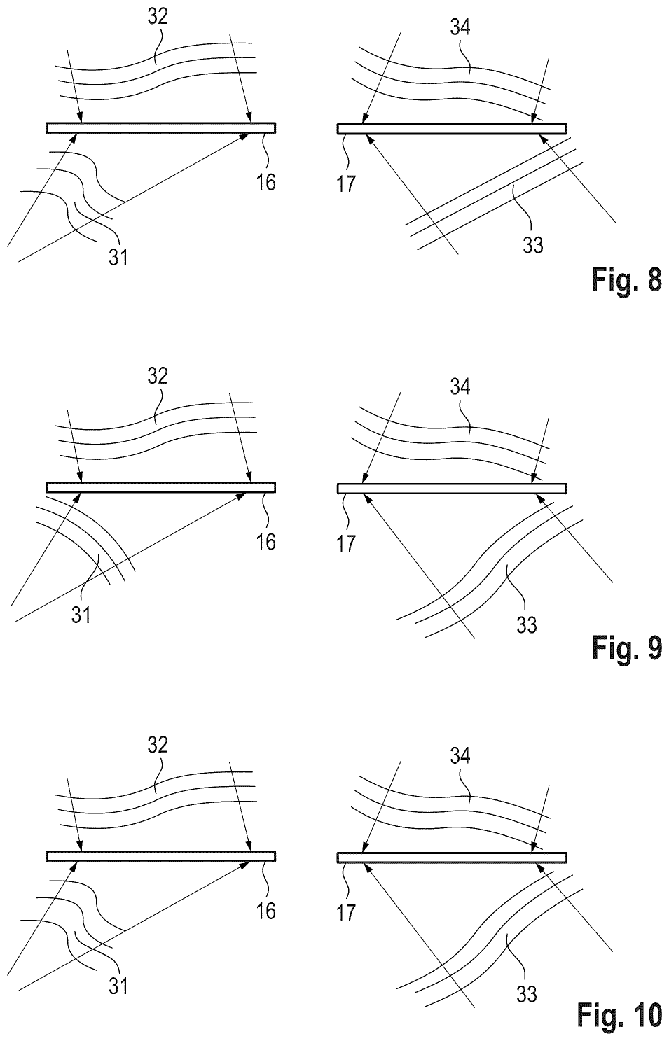

In the variant as shown in FIG. 8, in a departure from the variant shown in FIG. 6, the wavefront 31 is designed as a freeform wavefront. In the variant as shown in FIG. 9, in a departure from the variant shown in FIG. 6, the wavefront 33 is designed as a freeform wavefront.

The variant shown in FIG. 10 is suitable for applications with very high requirements. In this case, all four wavefronts 31-34 are designed as freeform wavefronts in order to realize a maximum number of degrees of freedom of the hologram stack.

In all the variants shown, the design wavefronts 32 and 34 need not be identical, but rather can differ from one another. Moreover, the holograms (13-17) or the holographic elements 11, 12 can be configured in curved fashion.

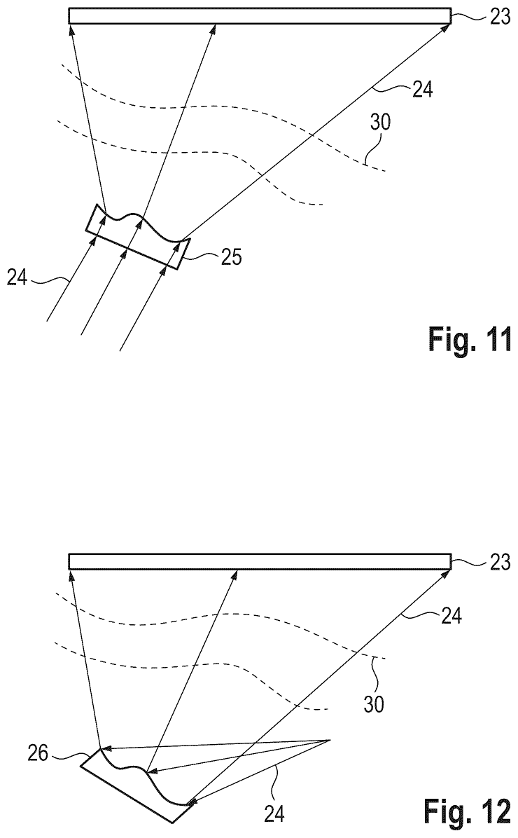

FIGS. 11 to 14 show variants of a method for producing a holographic arrangement 3 of the wavefront manipulator 7 as provided herein. Here in each case at least one hologram 23 is generated by exposure with at least one design wavefront 30 configured as a freeform wavefront. The hologram 23 shown by way of example can be one of the holograms 13 to 17. The beam path for exposure of the hologram 23 is identified in each case by the reference numeral 24. The variants shown in FIGS. 11 to 14 can be combined with one another in any desired way.

In the variant shown in FIG. 11, a freeform design wavefront is generated by means of a freeform lens 25 and is used for exposure of the hologram 23. The lens 25 shown has a freeform surface and a plane surface. As an alternative thereto, the lens 25 can also have a freeform surface on both surfaces in the beam path 24. Moreover, a plurality of freeform lenses can also be combined with one another, i.e. arranged one behind another in the beam path 24.

In the variant shown in FIG. 12, a freeform design wavefront is generated by means of a freeform mirror 26 and is used for exposure of the hologram 23. A freeform mirror 26 has a reflective surface having a freeform curvature and in this way modulates the wavefront as a freeform wavefront.

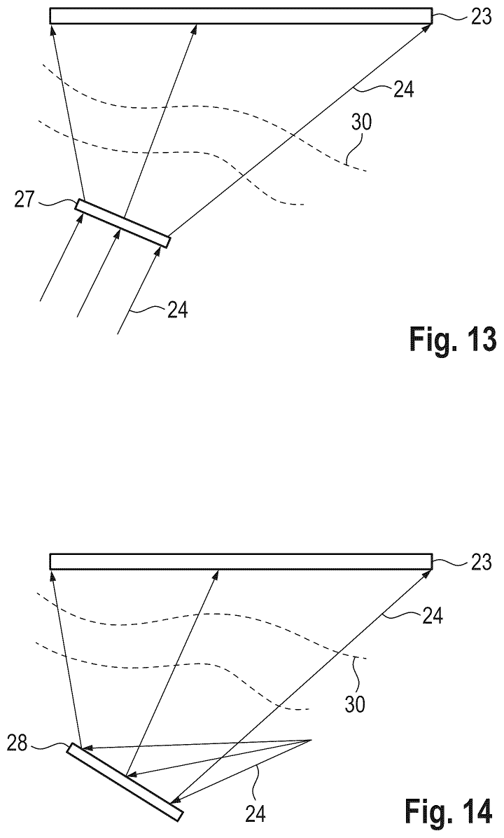

In the variants shown in FIGS. 13 and 14, a freeform design wavefront is generated by means of a holographic element 27, 28 and is used for exposure of the hologram 23. The wavefront is modulated as a freeform wavefront by means of the holographic element 27, 28. In this case, a freeform transmission hologram 27 is used in the variant shown in FIG. 13, and a freeform reflection hologram 28 is used in the variant shown in FIG. 14.

### LIST OF REFERENCE SIGNS

1 Picture generating unit
2 Optical arrangement
3 Holographic arrangement
4 Projection surface
5 Eyebox
7 Wavefront manipulator
8 Beam path
10 Head-up display
11 First holographic element
12 Second holographic element
13 Hologram
14 Hologram
15 Hologram
16 Hologram
17 Hologram
19 Beam path
20 Beam path
21 Beam path
22 Center axis
23 Hologram
24 Beam path
25 Freeform lens
26 Freeform mirror
27 Freeform transmission hologram
28 Freeform reflection hologram
30 Freeform design wavefront
31 Design wavefront
32 Design wavefront
33 Design wavefront
34 Design wavefront
35 Wavefront
36 Wavefront
37 Wavefront

What is claimed is:

1. A wavefront manipulator comprising:
a holographic arrangement for arrangement in a beam path of a head-up display between a picture generating unit and a projection surface,
wherein the holographic arrangement is configured for arrangement as the sole aberration correction element between the picture generating unit and the projection surface.

2. The wavefront manipulator of claim 1, wherein the holographic arrangement is configured for correcting a plurality of aberrations.

3. The wavefront manipulator of claim 1, wherein the holographic arrangement comprises a plurality of holograms which are configured to be transmissive and/or reflective.

4. The wavefront manipulator of claim 1,
wherein the holographic arrangement comprises at least two holographic elements which are arranged one directly behind another at least in portions in the beam path and are configured to be reflective for at least one defined wavelength and a defined angle of incidence range, and
wherein a first holographic element comprises at least one hologram which is assigned to a hologram of a second holographic element for reflection purposes.

5. The wavefront manipulator of claim 4, wherein the at least two holographic elements comprise reflection holograms recorded with two design wavefronts, of which at least one design wavefront is a freeform wavefront.

6. The wavefront manipulator of claim 4, wherein the at least two holographic elements comprise reflection holograms, wherein at least one reflection hologram is recorded with two design wavefronts, and wherein at least one of the design wavefronts is configured such that it is generated in accordance with a function having a plurality of degrees of freedom.

7. The wavefront manipulator of claim 1, wherein the holographic arrangement is configured in curved fashion.

8. The wavefront manipulator of claim 1, wherein the holographic arrangement is configured for at least partly correcting at least one aberration which is caused by a curvature of the projection surface and/or by the picture generating unit and/or by the course of the beam path and/or by at least one optical element in the beam path and/or by a tilting of the image plane.

9. A method for producing a holographic arrangement of a wavefront manipulator for arrangement in a beam path of a head-up display between a picture generating unit and a projection surface, wherein the holographic arrangement is configured for arrangement as the sole aberration correction element between the picture generating unit and the projection surface, the method comprising:
generating at least one hologram by exposure with at least one design wavefront configured as a freeform wavefront.

10. The method of claim 9, wherein the at least one freeform wavefront is generated via a freeform lens and/or a freeform mirror and/or a freeform hologram.

11. An optical arrangement for a head-up display, the optical arrangement comprising:
a picture generating unit, and
the wavefront manipulator according to claim 1.

12. The optical arrangement of claim 11, wherein the optical arrangement does not comprise a mirror.

13. A head-up display comprising the optical arrangement of claim 11.

14. The head-up display of claim 13, wherein the head-up display does not comprise a mirror in the beam path proceeding from the picture generating unit as far as a projection surface.
